(19) United States
(12) Patent Application Publication
(10) Pub. No.: US 2022/0206127 A1
(43) Pub. Date: Jun. 30, 2022

(54) Phase-coded unsaturated modulation method, apparatus, lidar distance and velocity measurement method and lidar system

(71) Applicant: Beijing Guangshao Technology Co., Ltd, Beijing (CN)

(72) Inventors: Cunhui LI, Beijing (CN); Jian YAO, Beijing (CN); Shumin ZHANG, Beijing (CN); Xiaojin FU, Beijing (CN)

(21) Appl. No.: 17/655,029

(22) Filed: Mar. 16, 2022

Related U.S. Application Data
(63) Continuation of application No. PCT/CN2019/107358, filed on Sep. 23, 2019.

(30) Foreign Application Priority Data
Sep. 19, 2019 (CN) 201910886491.7
Sep. 19, 2019 (CN) 201921561613.7

(51) Int. Cl. G01S 7/4911; G01S 17/58; G01S 17/06; G01S 7/481

(52) U.S. Cl. CPC G01S 7/4911; G01S 17/58; G01S 7/4816; G01S 7/4814; G01S 17/06

(57) ABSTRACT

The present invention relates to a phase coded unsaturated modulation method and apparatus, distance and velocity measurement method using lidar and lidar system, by using phase-unsaturated modulation, a modulated laser signal includes both a single-frequency component and a phase-modulated component with the same or close energy ratio, wherein the single-frequency component can be used to obtain the velocity of relative motion between the platform and the target and to compensate for the frequency drift of a seed laser, the obtained relative Doppler frequency is used to construct a matched filter function to perform pulse compression of the phase-coded signal, and further to obtain the distance information between the target and the platform. The invention can simultaneously complete distance and velocity measurement with high accuracy, low error, small calculations and low system complexity.

### CROSS REFERENCE TO RELATED APPLICATION

This application is a continuation-in-part of International Patent Application No. PCT/CN2019/107358, filed on Sep. 23, 2019, which claims priority benefit of Chinese Patent Application No. 201910886491.7, filed on Sep. 19, 2019 and Chinese Patent Application No. 201921561613.7, filed on Sep. 19, 2019, and the entire contents of which are incorporated herein by reference.

### TECHNICAL FIELD

The present invention relates to the field of lidar, and in particular to a phase-coded unsaturated modulation method, apparatus, lidar distance and velocity measurement method and lidar system.

### BACKGROUND

Pulse compression is an important system of modern radar, which effectively solves the contradiction between distance resolution and average power of radar and is widely used in modern radar. There are three types of typical pulse compression signals: linear frequency modulation (LFM) signals, nonlinear frequency modulation (NLFM) signals and phase coded (PSK) signals, among which phase coded signals are widely used because of large main lobe to side lobe ratios and good compression performance of their frequency spectrum in the case of small time-bandwidth products, and because phase coded uses pseudo-random sequence signals, it is easy to realize signal “agility”, which is conducive to improving the interception resistance of radar systems, but the shortcoming is that in the process of pulse compression of the target echo signal, the phase coded signal will make the echo signal subject to Doppler modulation due to the target and the platform, as well as the frequency change of the seed laser carrier during the round-trip time of the radar signal, at the same time due to the existence of relative motion Doppler of the platform and target, the matched filter function becomes completely mismatched, and the phase-coded signal cannot obtain the relative distance information between the target and the platform through the pulse compression process, based on the Doppler-sensitive nature of the phase-coded signals, and the pulse compression performance will be seriously affected when the Doppler frequency shift exists in the echo signal, therefore, it is necessary to compensate for the Doppler caused by the relative motion between the target and the platform, especially in the case of high carrier frequency, large Doppler frequency shift of the relative motion of the target and poor stability of the seed laser frequency, such as lidar. Therefore, there is a need to improve the existing technology to effectively solve the Doppler sensitivity problem of conventional phase-coded signals, and at the same time to achieve the measurement of the relative motion velocity of the target.

### SUMMARY

The purpose of the present invention is to overcome the defects of the prior art, and to provide a phase-coded unsaturated modulation method, apparatus, lidar distance and velocity measurement method and lidar system, which adopt the phase unsaturated modulation method to make the modulated laser signal simultaneously have a single-frequency component and a phase-coded modulation components, of which the single-frequency component can be used to obtain the relative motion velocity between the platform and the target and to compensate for the frequency drift of the seed laser. The obtained relative Doppler frequency is used to construct a matched filter function to perform pulse compression of the phase-coded signal, and further to obtain the distance information between the target and the platform.

The solution in the present invention is: a phase coded unsaturated modulation method for phase coded modulation of a single frequency laser, wherein the phase coded modulation is two-phase or multi-phase, and modulation depth is phase unsaturated modulation.

Further, when the phase coded modulation is a two-phase code, the signal modulation is:

Sig(t)=A exp[j(2πf₀t+φ(t))]

φ(t)=(n±η)π

wherein Sig(t) is an output laser modulated signal, A is the amplitude of the laser signal, f₀ is the carrier frequency of the laser, φ(t) is the phase modulated signal, n is an integer, η is 0.2˜0.8.

Further, η is 0.4˜0.6.

Further, after the phase coded unsaturated modulation, the laser signal comprises a single-frequency spectral component and a phase coded modulated broadband spectral component with the same or close energy ratio, wherein the phase coded modulated broadband spectral component is a phase coded spectral component.

Further, the energy ratio of the single-frequency spectral components is 40%-60%.

The present invention further provides a phase coded unsaturated modulation apparatus for implementing the above phase coded unsaturated modulation method, comprising: a laser generator, a laser phase modulator and a signal generator, the laser generator is arranged to emit a single frequency laser, the laser emitting end of the laser generator is connected to the optical input of the laser phase modulator, the signal generator is arranged to generate a phase coded modulated electrical signal, the electrical signal output of the signal generator is connected to the signal input of the laser phase modulator, said single frequency laser is phase coded unsaturated modulated in the laser phase modulator.

The present invention further provides a lidar distance and velocity measurement method based on the above phase coded unsaturated modulation method, comprising the steps of:

step S1: performing phase coded unsaturated modulation of a single-frequency laser,

step S2: emitting the laser signal after the phase coded unsaturated modulation and amplification, and then performing heterodyne mixing and photoelectric conversion between echo laser reflected by the target and the single frequency laser to obtain an intermediate frequency electrical signal after the heterodyne,

step S3: processing said intermediate frequency electrical signal to convert it to an intermediate frequency complex signal,

step S4: performing Fourier transform of the intermediate frequency complex signal to obtain a signal spectrum,

step S5: performing data processing of the signal spectrum obtained after the Fourier transform and the intermediate frequency complex signal to obtain velocity information and distance information, thus completing the lidar distance and velocity measurement.

Further, said step S1 further comprises pulse width modulation of the single frequency laser, the laser signal being in continuous, quasi-continuous or pulsed wave form after the pulse width modulation. The frequency shift of the laser frequency can also be performed simultaneously during the modulation process.

Further, said step S1 further comprises frequency modulation of the single frequency laser, the laser signal having a certain frequency difference from the original single-frequency laser after the frequency modulation.

Further, in said step S3, said process of converting the intermediate frequency complex signal is implemented using a hardware structure or a data processing algorithm.

Further, said step S5 further comprises the steps of:

S51: comparing the single-frequency spectral component obtained after the Fourier transform of the intermediate frequency signal with a frequency signal intensity threshold to obtain a single-frequency peak points array with greater intensity than the frequency signal intensity threshold, thereby obtaining the Doppler magnitude and direction of the relative motion between the lidar and the target,

S52: processing the single-frequency peak points array to obtain a velocity array, wherein the velocity array represents velocity information,

S53: constructing a matched filter function by using the single frequency peak points array, performing pulse compression of the matched filter function and the phase coded spectral components of the intermediate frequency complex signal, and comparing the compressed data information with a distance signal intensity threshold, and the points greater than the distance signal intensity threshold form a distance array, wherein the distance array represents distance information; and

S54: outputting the velocity array and the distance array.

The present invention further provides a lidar system for performing the above lidar distance and velocity measurement method, comprising: a laser generator, a laser phase modulator, a laser amplifier, a laser demodulator, a photodetector, a data acquisition processor and a signal generator, the laser generator being arranged to emit a single frequency laser, the laser emitting end of the laser generator being connected to the optical input of the laser demodulator and the optical input of the laser phase modulator. The signal generator for generating a phase coded modulated electrical signal, the electrical signal output of the signal generator being connected to the signal input of the laser phase modulator, said single frequency laser being phase coded unsaturated modulated in said laser phase modulator, the optical output of the laser phase modulator is connected to the optical input of the laser amplifier, the optical output of the laser amplifier is connected to an optical transceiver circuit, the optical transceiver circuit is arranged to emit the laser signal generated by the laser amplifier and to introduce a received echo signal reflected by the target into the optical input of the laser demodulator, the optical output of the laser demodulator is connected to the photodetector, and the photodetector is connected to the data acquisition processor.

Further, a pulse width modulator may be provided, said pulse width modulator is provided between said laser generator and said laser phase modulator, and the pulse width modulator may also be provided with the function of shifting the frequency of the laser signal.

Further, a circulator may be provided, said circulator is provided between said laser amplifier and said optical transceiver circuit.

The present invention also provides another lidar distance and velocity measurement method, based on one of the above-mentioned phase-encoded unsaturated modulation methods, comprising the steps of:

step S6: performing phase coded unsaturated modulation of a single-frequency laser,

step S7: emitting the laser signal after the phase coded unsaturated modulation and amplification, and then performing heterodyne mixing and photoelectric conversion between echo laser reflected by the target and the single frequency laser to obtain an intermediate frequency electrical signal after the heterodyne,

step S8: performing Fourier transform of the intermediate frequency electrical signal to obtain a signal spectrum,

step S9: performing data processing of the signal spectrum obtained after the Fourier transform and the intermediate frequency electrical signal to obtain velocity information and distance information, thus completing the lidar distance and velocity measurement.

Further, said step S6 further comprises pulse width modulation of the single frequency laser, the laser signal being in continuous, quasi-continuous or pulsed wave form after the pulse width modulation, and the modulation process requires a frequency shift of the laser frequency.

Further, said step S9 further comprises the steps of:

S91: comparing the single-frequency spectral component obtained after the Fourier transform of the intermediate frequency signal with a frequency signal intensity threshold to obtain a single-frequency peak points array with greater intensity than the frequency signal intensity threshold, thereby obtaining the Doppler magnitude and direction of the relative motion between the lidar and the target,

S92: processing the single-frequency peak points array to obtain a velocity array, wherein the velocity array represents velocity information,

S93: constructing a matched filter function by using the single frequency peak points array, performing pulse compression of the matched filter function and the phase coded spectral components of the intermediate frequency signal, and comparing the compressed data information with a distance signal intensity threshold, and the points greater than the distance signal intensity threshold form a distance array, wherein the distance array represents distance information; and

S94: outputting the velocity array and the distance array.

The present invention further provides a lidar system for performing the above lidar distance and velocity measurement method, comprising: a laser generator, a laser phase modulator, a laser amplifier, a laser demodulator, a photodetector, a data acquisition processor and a signal generator, the laser generator being arranged to emit a single frequency laser, the laser emitting end of the laser generator being connected to the optical input of the laser demodulator and the optical input of the laser phase modulator. The optical input of the laser demodulator can also be connected to another laser generator. The signal generator for generating a phase coded modulated electrical signal, the electrical signal output of the signal generator being connected to the signal input of the laser phase modulator, said single frequency laser being phase coded unsaturated modulated in said laser phase modulator, the optical output of the laser phase modulator is connected to the optical input of the laser amplifier, the optical output of the laser amplifier is connected to an optical transceiver circuit, the optical transceiver circuit is arranged to emit the laser signal generated by the laser amplifier and to introduce a received echo signal reflected by the target into the optical input of the laser demodulator, the optical output of the laser demodulator is connected to the photodetector, and the photodetector is connected to the data acquisition processor.

Further, a pulse width modulator may be provided, said pulse width modulator is provided between said laser generator and said laser phase modulator, and the pulse width modulator may also be provided with the function of shifting the frequency of the laser signal.

Further, a circulator may be provided, said circulator is provided between said laser amplifier and said optical transceiver circuit.

The present invention has the following beneficial effects:

1) the relative motion velocity and distance information between the target and the platform can be obtained simultaneously using the phase-coded unsaturated modulated signal, and the velocity/Doppler dimension detection can be obtained compared with the existing phase-coded technique, further enhancing the Doppler tolerance of the existing phase-coded modulation technique.

2) The technical solution of the present invention can obtain the motion velocity information of the target even when the echo signal has a very low signal-to-noise ratio (<OdB), and the detection sensitivity of the system is higher compared with the existing techniques using a scheme for detecting motion velocity by multiplying intermediate frequency orthogonal phase coded signals.

(3) The unsaturated modulated signal form has the same carrier, generation time and propagation path in the velocity and distance dimensions, so the errors caused by Doppler and environmental errors on the distance velocity signal components are identical and are common-mode errors, which can be subsequently eliminated by means of signal processing.

(4) The phase-coded unsaturated modulation method only requires one Fourier transform of the echo signal to obtain the Doppler frequency of the target relative motion, which does not require a complex iterative signal processing and effectively reduces the system computation.

(5) The technical solution of the present invention adopts unsaturated modulation method, only one level of modulator can be used to complete the unsaturated phase-coded unsaturated modulation, so that the complexity of the system is significantly reduced.

### BRIEF DESCRIPTION OF THE DRAWINGS

In order to make the technical solution of the invention clear and complete, a brief description of the drawings in the description of the invention will be given below. It is obvious that the drawings in the following description are only some embodiments of the invention, and that other drawings can be obtained from these drawings without creative work for a person skilled in the art.

FIG. 1 shows a form of time domain signals after phase coded unsaturated modulation heterodyne.

FIG. 2 shows a form of frequency domain signals after phase coded unsaturated modulation heterodyne.

FIG. 3 is a system schematic of the phase-encoded unsaturated modulation device.

FIG. 4 is a flow chart of the lidar distance and velocity measurement method based on phase coded unsaturated modulation.

FIG. 5 is a schematic diagram of the lidar distance and velocity measurement system.

FIG. 6 is another flow chart of the lidar distance and velocity measurement method based on phase coded unsaturated modulation.

FIG. 7 is another schematic diagram of the lidar distance and velocity measurement system.

FIG. 8 is another schematic diagram of the lidar distance and velocity measurement system.

Wherein, the above drawings include the following reference signs: 1. single frequency spectrum component; 2. phase coded spectrum component; 3. single frequency laser; 4. echo laser; 5. intermediate frequency electrical signal; 6. intermediate frequency complex signal; 7. signal spectrum; 8. frequency signal intensity threshold; 9. single-frequency peak points array; 10. matched filter function; 11. pulse compression; 12. distance signal intensity threshold; 13. velocity array; 14. distance array; 15. cyclic Operation; 16. laser generator; 17. modulator; 18. laser phase modulator; 19. laser amplifier; 20. circulator; 21. optical transceiver circuit; 22. laser demodulator; 23. photodetector; 24. data acquisition processor; 25. signal generator; 26. another laser generator.

### DETAILED DESCRIPTION

The technical solution of the present invention will be clearly and completely described below in combination of the drawings, and it is clear that the described embodiments are a part of the embodiments of the present invention, and not all of them. Based on the embodiments in the present invention, all other embodiments obtained by a person skilled in the art without creative work fall within the scope of protection of the present invention.

### Example 1

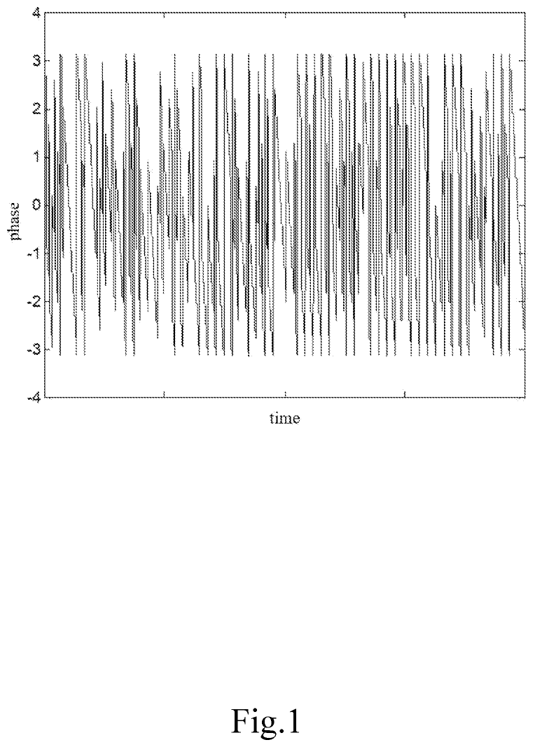

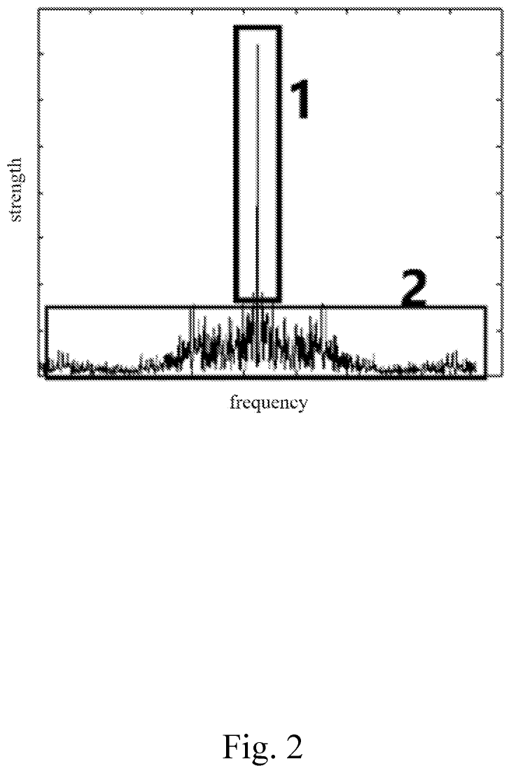

Referring to FIG. 1-2, a phase coded unsaturated modulation method, comprising: performing phase coded modulation of a single frequency laser outputted by a laser generator 16, the phase coded modulation is in the form of two-phase or multi-phase, the modulation depth is phase unsaturated modulation, when the phase coded form is two-phase code, the phase unsaturated modulation of the signal modulation is in the form of:

Sig(t)=A exp[j(2πf₀t+φ(t))]

φ(t)=(n±η)π

wherein Sig(t) is an output laser modulated signal, A is the amplitude of the laser signal, f₀ is the carrier frequency of the laser, φ(t) is the phase modulated signal, n is an integer (e.g. −1, 0, 1 . . . ), η is 0.2˜ 0.8 (preferably 0.4˜0.6).

The laser signal after phase coded unsaturated modulation includes a single frequency spectral component 1 and a phase coded modulated broadband spectral component, the phase coded modulated broadband spectral component is a phase coded spectral component 2, both of the two components have the same or close energy ratio, with said single frequency spectral component 1 has an energy ratio of 40%-60%.

### Example 2

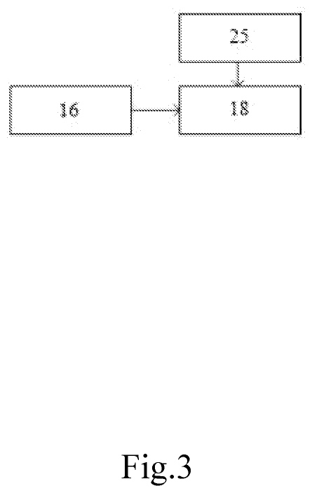

Referring to FIG. 3, a phase coded unsaturated modulation apparatus, comprising: a laser generator 16, a laser phase modulator 18 and a signal generator 25, the laser generator 16 is arranged to emit a single frequency laser, the laser emitting end of the laser generator 16 is connected to the optical input of the laser phase modulator 18, the signal generator 25 is configured to generate a phase coded modulated electrical signal, the output of the signal generator 25 is connected to the signal input of the laser phase modulator 18, the single-frequency laser is phase coded unsaturated modulated in the laser phase modulator 18, and the laser signal after phase coded unsaturated modulation includes a single-frequency spectral component and a phase-coded modulated broadband spectral component, and the energy ratio of the two components is the same or close to each other.

### Example 3

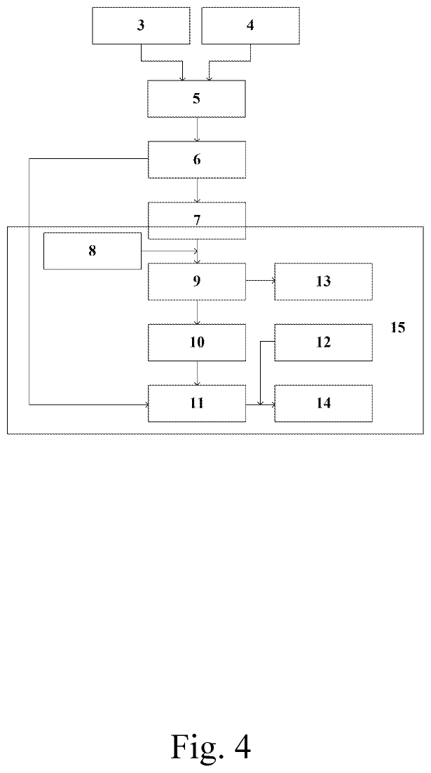

Referring to FIG. 4, a lidar distance and velocity measurement method, specifically comprises the following steps:

Step S1: performing phase-coded unsaturated modulation of the single-frequency laser outputted by the laser generator 16 using the method in Example 1. Step S1 further comprises performing pulse width modulation and frequency modulation of the single frequency laser outputted by the laser generator 16.

Step S2: emitting the laser signal after phase coded unsaturation modulation and amplification, and then performing heterodyne mixing and photoelectric conversion between echo laser 4 reflected by the target and the single frequency laser 3 to obtain an intermediate frequency electrical signal 5 after the heterodyne.

Step S3: processing said intermediate frequency electrical signal to convert it to an intermediate frequency complex signal 6.

The process of laser demodulation 5 can be implemented using a hardware structure such as an optical or electronic quadrature demodulator or with a 3 dB coupler combined with a data processing algorithm such as Hilbert transform.

Step S4: Performing Fourier transform of the intermediate frequency complex signal 6 to obtain a signal spectrum 7.

Step S5: Performing data processing on the signal spectrum 7 obtained after the Fourier transform and the intermediate frequency complex signal 6 to obtain velocity information and distance information, thus completing the Lidar distance and velocity measurement.

The data processing in step S5 specifically includes the following steps:

S51: comparing the single-frequency spectral component of said signal spectrum 7 obtained after Fourier transform with a frequency signal intensity threshold 8 to obtain a single-frequency peak points array 9 with greater intensity than the frequency signal intensity threshold 8, thereby obtaining the Doppler magnitude and direction of the relative motion between the lidar and the target,

S52: processing the single-frequency peak point array 9 to obtain a velocity array 13, wherein the velocity array 13 represents velocity information,

S53: constructing a matched filter function 10 by using elements of the single frequency peak points array 9, performing pulse compression 11 of the matched filter function 10 and the phase coded spectral components in the intermediate frequency complex signal 6, and comparing the compressed data information with a distance signal intensity threshold 12, and the points greater than the distance signal intensity threshold 12 form a distance array 14, wherein the distance array 14 represents distance information; and

S54: outputting the velocity array 13 and the distance array 14.

### Example 4

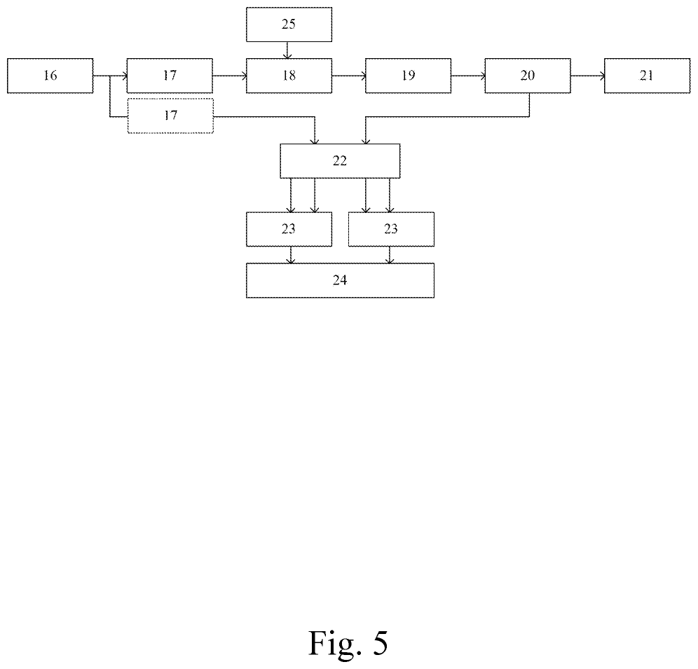

Referring to FIG. 5, a lidar system for performing the lidar distance and velocity measurement method in Example 3, specifically comprising the following components: a laser generator 16, a laser phase modulator 18, a laser amplifier 19, an optical transceiver circuit 21, a laser demodulator 22, a photodetector 23, a data acquisition processor 24, a signal generator 25.

The laser generator 16 is used to emit a single frequency laser, the laser emitting end of the laser generator 16 is connected to the optical input of the laser phase modulator 18 and the optical input of the laser demodulator 22, the signal generator 25 is used to emit phase coded modulated electrical signal, the signal output of the signal generator 25 is connected to the signal input of the laser phase modulator 18, the single frequency laser is phase coded unsaturated modulated in the laser phase modulator 18, the laser signal after phase coded unsaturated modulation includes a single frequency spectral component and a phase coded modulated broadband spectral component, and the energy ratio of the two components is the same or close to each other.

The optical output of the laser phase modulator 18 is connected to the optical input of the laser amplifier 19, and the optical output of the laser amplifier 19 is connected to the optical transceiver circuit 21, and optical transceiver circuit 21 transmits the laser signal generated by the laser amplifier 19, and at the same time introduces the received echo signal 4 reflected by the target into the optical input of the laser demodulator 22, and the optical output of the laser demodulator 22 is connected to the photodetector 23, and the photodetector 23 is connected to the data acquisition processor 24, and the optical transceiver circuit 21 is a device used for laser emitting and echo laser reception.

The above lidar system may also be provided with a modulator 17, said modulator 17 is arranged between said laser generator 16 and said laser phase modulator 18, or between said laser generator 16 and said laser demodulator 22.

The modulator 17 is a pulse width modulator, wherein the laser signal is in continuous, quasi-continuous or pulsed wave form after the pulse width modulation; or the modulator 17 is a pulse frequency modulator, wherein the input laser signal can be frequency modulated; or the modulator 17 is a pulse width frequency modulator, wherein the input laser signal can be pulse width modulated and frequency modulated at the same time.

The above lidar system may also be provided with a circulator 20, said circulator 20 is provided between said laser amplifier 19 and said optical transceiver circuit 21.

The laser demodulator 22 can use quadrature demodulation to obtain a 4-way optical mixing signal with a phase difference of 90°, or 3 dB coupling to obtain a 2-way optical mixing signal with a phase difference of 180°.

If the laser demodulator 22 is a quadrature demodulator, two photoelectric detectors 23 need to be connected, signals with a phase difference of 0° and 180° enter into one detector and signals with a phase difference of 90° and 270° enter into another detector.

If the laser demodulator 22 is a 3 dB coupler, one photodetector 23 needs to be connected.

The single-frequency laser outputted by the laser generator 16 is modulated by the pulse width/frequency modulator 17 and then enters the laser phase modulator 18 for phase-coded unsaturated modulation, the laser signal after the phase-coded unsaturated modulation enters into the circulator 20 through the laser amplifier 19, the circulator 20 is connected to the optical transceiver circuit 21 for laser emission, the target reflected echo signal received by the optical transceiver circuit 21 is connected to the circulator 20 to form an echo laser 4. The single-frequency laser 3 and the echo laser 4 enter laser demodulator 22 for heterodyne demodulation, and the demodulated laser signal enters the photodetector 23 and data acquisition processor 24 for signal processing.

The laser demodulator 22 in the heterodyne demodulation process can be a quadrature demodulator to obtain a four-way optical signal with a phase difference of 90°, or a 3 dB coupler to obtain a two-way optical signal with a phase difference of 180°.

### Example 5

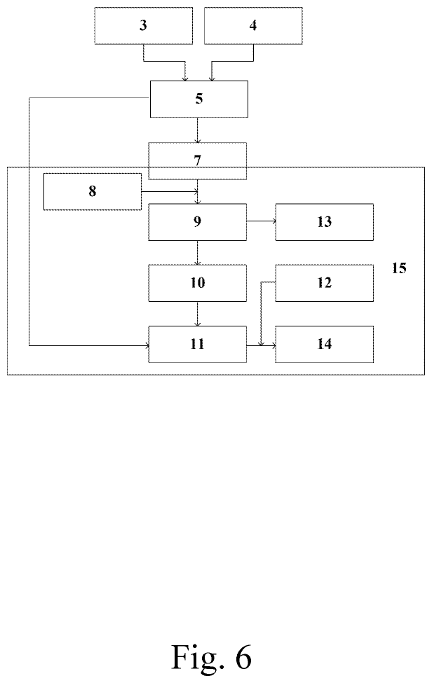

Referring to FIG. 6, another lidar distance and velocity measurement method, specifically comprises the following steps:

Step S6: performing phase-coded unsaturated modulation of the single-frequency laser outputted by the laser generator 16 using the method in Example 1. Step S1 further comprises performing pulse width modulation and frequency modulation of the single frequency laser outputted by the laser generator 16.

Step S7: emitting the laser signal after phase coded unsaturation modulation and amplification, and then performing heterodyne mixing and photoelectric conversion between echo laser 4 reflected by the target and the single frequency laser 3 to obtain an intermediate frequency electrical signal 5 after the heterodyne.

Step S8: Performing Fourier transform said intermediate frequency electrical signal 5 to obtain a signal spectrum 7.

Step S9: Performing data processing on the signal spectrum 7 obtained after the Fourier transform and the intermediate frequency electrical signal 5 to obtain velocity information and distance information, thus completing the lidar distance and velocity measurement.

The data processing in step S9 specifically includes the following steps:

S91: comparing the single-frequency spectral component of said signal spectrum 7 obtained after Fourier transform with a frequency signal intensity threshold 8 to obtain a single-frequency peak points array 9 with greater intensity than the frequency signal intensity threshold 8, thereby obtaining the Doppler magnitude and direction of the relative motion between the lidar and the target,

S92: processing the single-frequency peak point array 9 to obtain a velocity array 13, wherein the velocity array 13 represents velocity information,

S93: constructing a matched filter function 10 by using elements of the single frequency peak points array 9, performing pulse compression 11 of the matched filter function 10 and the phase coded spectral components in the intermediate frequency signal 5, and comparing the compressed data information with a distance signal intensity threshold 12, and the points greater than the distance signal intensity threshold 12 form a distance array 14, wherein the distance array 14 represents distance information; and

S94: outputting the velocity array 13 and the distance array 14.

### Example 6

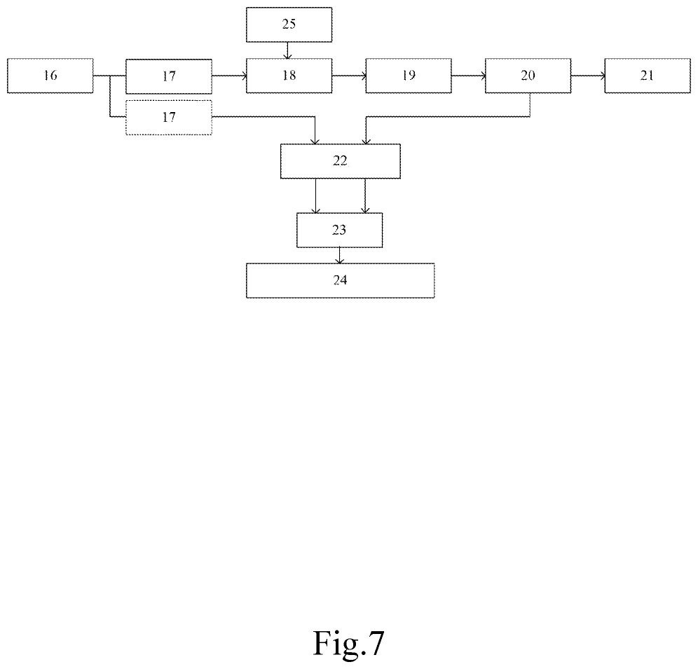

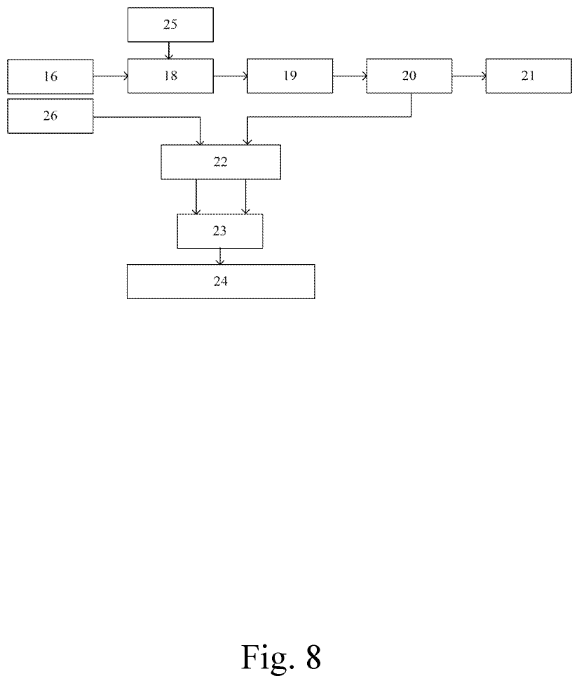

Referring to FIG. 7-8, another lidar system for performing the lidar distance and velocity measurement method in Example 5, specifically comprising the following components: a laser generator 16, a laser phase modulator 18, a laser amplifier 19, an optical transceiver circuit 21, a laser demodulator 22, a photodetector 23, a data acquisition processor 24, a signal generator 25 and another laser generator 26.

The laser generator 16 is used to emit a single frequency laser, the laser emitting end of the laser generator 16 is connected to the optical input of the laser phase modulator 18 and the optical input of the laser demodulator 22, the optical input of the laser demodulator 22 can also be connected to the optical output of another laser generator 26, the signal generator 25 is used to emit phase coded modulated electrical signal, the signal output of the signal generator 25 is connected to the signal input of the laser phase modulator 18, the single frequency laser is phase coded unsaturated modulated in the laser phase modulator 18, the laser signal after phase coded unsaturated modulation includes a single frequency spectral component and a phase coded modulated broadband spectral component, and the energy ratio of the two components is the same or close to each other.

The optical output of the laser phase modulator 18 is connected to the optical input of the laser amplifier 19, and the optical output of the laser amplifier 19 is connected to the optical transceiver circuit 21, and optical transceiver circuit 21 transmits the laser signal generated by the laser amplifier 19, and at the same time introduces the received echo signal 4 reflected by the target into the optical input of the laser demodulator 22, and the optical output of the laser demodulator 22 is connected to the photodetector 23, and the photodetector 23 is connected to the data acquisition processor 24, and the optical transceiver circuit 21 is a device used for laser emitting and echo laser reception.

The above lidar system may also be provided with a modulator 17, said modulator 17 is arranged between said laser generator 16 and said laser phase modulator 18, or between said laser generator 16 and said laser demodulator 22.

The modulator 17 is a pulse width modulator, wherein the laser signal is in continuous, quasi-continuous or pulsed wave form after the pulse width modulation; or the modulator 17 is a pulse frequency modulator, wherein the input laser signal can be frequency modulated; or the modulator 17 is a pulse width frequency modulator, wherein the input laser signal can be pulse width modulated and frequency modulated at the same time.

The above lidar system may also be provided with a circulator 20, said circulator 20 is provided between said laser amplifier 19 and said optical transceiver circuit 21.

The laser demodulator 22 can use 3 dB coupling to obtain a 2-way optical mixing signal with a phase difference of 180°.

If the laser demodulator 22 needs to be connected to one photodetector 23.

The single-frequency laser outputted by the laser generator 16 is modulated by the pulse width/frequency modulator 17 and then enters the laser phase modulator 18 for phase-coded unsaturated modulation, the laser signal after the phase-coded unsaturated modulation enters into the circulator 20 through the laser amplifier 19, the circulator 20 is connected to the optical transceiver circuit 21 for laser emission, the target reflected echo signal received by the optical transceiver circuit 21 is connected to the circulator 20 to form an echo laser 4. The single-frequency laser 3 and the echo laser 4 enter laser demodulator 22 for heterodyne demodulation, and the demodulated laser signal enters the photodetector 23 and data acquisition processor 24 for signal processing.

The above embodiments are preferable embodiments of the present invention, but the implementation of the present invention is not limited by the above embodiments, any other changes, modifications, alternatives, combinations, simplifications made without deviating from the spirit and principle of the present invention shall be equivalent substitutions and are included in the scope of protection of the present invention.

1. A phase coded unsaturated modulation method for phase coded modulation of a single frequency laser, characterized in that the phase coded modulation is two-phase or multi-phase, and modulation depth is phase unsaturated modulation.

2. The phase coded unsaturated modulation method according to claim 1, characterized in that: when the phase coded modulation is a two-phase code, the signal modulation is:
Sig(t)=A exp[j(2πf₀t+φ(t))]
φ(t)=(n±η)π
wherein [symbol] is an output laser modulated signal, [symbol] is the amplitude of the laser signal, [symbol] is the carrier frequency of the laser, [symbol] is the phase modulated signal, [symbol] is an integer, [symbol] 0.2˜0.8.

3. The phase coded unsaturated modulation method according to claim 2, characterized in that: [symbol] is 0.4˜0.6.

4. The phase coded unsaturated modulation method according to claim 1, characterized in that: after the phase coded unsaturated modulation, the laser signal comprises a single-frequency spectral component and a phase coded modulated broadband spectral component with the same or close energy ratio, wherein the phase coded modulated broadband spectral component is a phase coded spectral component.

5. The phase coded unsaturated modulation method according to claim 4, characterized in that: the energy ratio of the single-frequency spectral components is 40%-60%.

6. A lidar distance and velocity measurement method based on the phase coded unsaturated modulation method according to claim 1, comprising the steps of:
step S1: performing phase coded unsaturated modulation of a single-frequency laser, step S2: emitting the laser signal after the phase coded unsaturated modulation and amplification, and then performing heterodyne mixing and photoelectric conversion between echo laser reflected by the target and the single frequency laser to obtain an intermediate frequency electrical signal after the heterodyne,
step S3: processing said intermediate frequency electrical signal to convert it to an intermediate frequency complex signal,
step S4: performing Fourier transform of the intermediate frequency complex signal to obtain a signal spectrum,
step S5: performing data processing of the signal spectrum obtained after the Fourier transform and the intermediate frequency complex signal to obtain velocity information and distance information, thus completing the lidar distance and velocity measurement.

7. A lidar distance and velocity measurement method based on the phase coded unsaturated modulation method according to claim 1, comprising the steps of:
step S6: performing phase coded unsaturated modulation of a single-frequency laser, step S7: emitting the laser signal after the phase coded unsaturated modulation and amplification, and then performing heterodyne mixing and photoelectric conversion between echo laser reflected by the target and the single frequency laser to obtain an intermediate frequency electrical signal after the heterodyne,
step S8: performing Fourier transform of the intermediate frequency electrical signal to obtain a signal spectrum,
step S9: performing data processing of the signal spectrum obtained after the Fourier transform and the intermediate frequency electrical signal to obtain velocity information and distance information, thus completing the lidar distance and velocity measurement.

8. The lidar distance and velocity measurement method according to claim 6, characterized in that: said step S1 further comprising pulse width modulation of the single frequency laser, the laser signal being in continuous, quasi-continuous or pulsed wave form after the pulse width modulation.

9. The lidar distance and velocity measurement method according to claim 6, characterized in that: said step S1 further comprising frequency modulation of the single frequency laser, the laser signal having a certain frequency difference from the original single-frequency laser after the frequency modulation.

10. The lidar distance and velocity measurement method according to claim 6, characterized in that: in said step S3, said process of obtaining the intermediate frequency complex signal is implemented using a hardware optical circuit structure or circuit structure or a data processing algorithm.

11. The lidar distance and velocity measurement method according to claim 6, characterized in that: said step S5 further comprising the steps of:
S51: comparing the single-frequency spectral component of said signal spectrum with a frequency signal intensity threshold to obtain a single-frequency peak points array with greater intensity than the frequency signal intensity threshold, thereby obtaining the Doppler magnitude and direction of the relative motion between the lidar and the target,
S52: processing the single-frequency peak points array to obtain a velocity array, wherein the velocity array represents velocity information,
S53: constructing a matched filter function by using the single frequency peak points array, performing pulse compression of the matched filter function and the phase coded spectral components in the intermediate frequency complex signal, and comparing the compressed data information with a distance signal intensity threshold, and the points greater than the distance signal intensity threshold form a distance array, wherein the distance array represents distance information; and
S54: outputting the velocity array and the distance array.

12. The lidar distance and velocity measurement method according to claim 7, characterized in that: said step S9 further comprising the steps of:
S91: comparing the single-frequency spectral component of said signal spectrum with a frequency signal intensity threshold to obtain a single-frequency peak points array with greater intensity than the frequency signal intensity threshold, thereby obtaining the Doppler magnitude and direction of the relative motion between the lidar and the target,
S92: processing the single-frequency peak point array to obtain a velocity array, wherein the velocity array represents velocity information,
S93: constructing a matched filter function by using the single frequency peak points array, performing pulse compression of the matched filter function and the phase coded spectral components in the intermediate frequency signal, and comparing the compressed data information with a distance signal intensity threshold, and the points greater than the distance signal intensity threshold form a distance array, wherein the distance array represents distance information; and
S94: outputting the velocity array and the distance array.

13. A lidar system for performing the lidar distance and velocity measurement method according to claim 6, comprising: a laser generator (16), a laser phase modulator (18), a laser amplifier (19), a laser demodulator (22), a photodetector (23), a data acquisition processor (24) and a signal generator (25), the laser generator (16) being arranged to emit a single frequency laser, the laser emitting end of the laser generator (16) being connected to the optical input of the laser demodulator (22) and the optical input of the laser phase modulator (18), the signal generator (25) for generating a phase coded modulated electrical signal, the electrical signal output of the signal generator (25) being connected to the signal input of the laser phase modulator (18), said single frequency laser being phase coded unsaturated modulated in said laser phase modulator (18), the optical output of the laser phase modulator (18) is connected to the optical input of the laser amplifier (19), the optical output of the laser amplifier (19) is connected to an optical transceiver circuit (21), the optical transceiver circuit (21) is arranged to emit the laser signal generated by the laser amplifier (19) and to introduce a received echo signal (4) reflected by the target into the optical input of the laser demodulator (22), the optical output of the laser demodulator (22) is connected to the photodetector (23), and the photodetector (23) is connected to the data acquisition processor (24).

14. The lidar system according to claim 13, characterized in that the laser demodulator (22) is an quadrature demodulator connected simultaneously with two photodetectors (23).

15. The lidar system according to claim 13, characterized in that the laser demodulator (22) is a 3 dB coupler connected to a photodetector (23).

16. The lidar system according to claim 13, further comprising a modulator (17), said modulator (17) being provided between said laser generator (16) and said laser phase modulator (18), or between said laser generator (16) and said laser demodulator (22).

17. The lidar system according to claim 16, characterized in that: said modulator (17) is one of: a pulse width modulator, a pulse frequency modulator, and a pulse width frequency modulator.

18. The lidar system according to claim 13, characterized in that it further comprises another laser generator (26), wherein the optical input of the laser demodulator (22) is not connected to the output of the laser generator (16), but to the output of the laser generator (26).

19. The lidar system according to claim 13, further comprising a circulator (20), said circulator (20) being provided between said laser amplifier (19) and said optical transceiver circuit (21).
